(19) United States
(12) Patent Application Publication
(10) Pub. No.: US 2009/0265133 A1
(43) Pub. Date: Oct. 22, 2009

(54) LOCALIZATION SYSTEM AND METHOD FOR MOBILE OBJECT USING WIRELESS COMMUNICATION

(76) Inventors: Moonhong Baek, Suwon (KR); Seungho Baek, Cheonan (KR); Jaehan Park, Siheung (KR); Hogil Lee, Ansan (KR); Daehee Won, Ansan (KR); Keeyoung Park, Suwon (KR)

Correspondence Address: IPLA P.A., 3580 WILSHIRE BLVD., 17TH FLOOR, LOS ANGELES, CA, 90010, US

(21) Appl. No.: 11/909,242

(22) PCT Filed: Aug. 1, 2006
(86) PCT No.: PCT/KR2006/003029

§ 371 Date: Sep. 20, 2007

(30) Foreign Application Priority Data
Aug. 1, 2005 (KR) 10-2005-0070116

(51) Int. Cl. G06F 15/00; G01B 11/14

(52) U.S. Cl. 702/150; 356/614

(57) ABSTRACT

The present invention relates to a localization system and method for a mobile object. An object of the present invention is to provide a localization system and method for a mobile object capable of obtaining precise stable position data against changes in light intensity and vibration of the mobile object and reducing operation loads of a control system disposed in the mobile object, as compared with a conventional case. Accordingly, the present invention provides a localization system for a mobile object mainly including a localization module which is mounted in the mobile object and comprises one or more optical indicators, an RF transceiving means, and a processing unit for receiving location information on the optical indicator from a sensing module and calculating a position and direction of the mobile object, and a sensing module which comprises an optical sensing means for detecting an optical signal emitted from the optical indicator of the localization module, an RF transceiving means, and a processing unit for obtaining the location information on the optical indicator from the optical signal detected by the optical sensing means. In addition, in the localization method according to the present invention, a position of the mobile object is not measured by using an own sensor disposed in the mobile object, and the localization module receives position information measured by the sensing module installed in outside through wireless communication and uses the position information to confirm a position thereof.

### TECHNICAL FIELD

The present invention relates to a localization system and method of measuring a position and direction of a mobile object, and more particularly, to a localization system and method capable of sensing an optical signal emitted from an optical indicator disposed in the mobile object by external optical sensing means installed in the surroundings and processing the optical signal to obtain location information on the optical indicator, thereby obtaining a position and direction of the mobile object from the location information.

### BACKGROUND ART

When a mobile object such as a service robot is to perform a moving activity for a certain service, the mobile object has to know its position and direction precisely. On this purpose, various systems and methods shown in the following description are proposed. However, these systems and methods also do not provide satisfactory solution, so need to be improved.

First, in a localization system using ultrasonic triangulation shown in FIG. 6, position of a mobile object is measured using three or more ultrasonic beacons. In this system, each ultrasonic transmitting device 1, 2, or 3 informs a receiver 4 of a transmission start reference signal through radio frequency (RF) before transmitting ultrasonic signals, and the receiver 4 then measures time difference of arrived ultrasonic signal and RF signal and then calculates distances L1, L2, and L3 proportional to the difference times. The receiver 4 is designed to calculate the position thereof by using known positions in space of the ultrasonic transmitting devices 1, 2, and 3.

However, there are problems in that, the ultrasonic transmitting devices 1, 2, and 3 have a limitation to the ultrasonic beam widths, and the receiver 4 has to be located within the range of the beams. Therefore, the perception area is limited. In addition, the sonic velocity changes according to temperature and humidity of the surroundings. Therefore, an accuracy of the measurement result decreases, and compensation for the effect of temperature and humidity is needed.

In addition, a localization method for a mobile object using a floor sheet on which barcodes are printed or RFID(radio frequency identification) Tag is implanted as shown in FIG. 7 is known. In this method, a barcode including position information is printed on the floor sheet, or an RFID tags are implanted into the floor sheet, and the mobile object moves on the floor sheets. Thereafter, the mobile object perceives a position thereof while moving on the floor sheets. In this case, there is an advantage in that relatively reliable information can be obtained. However, there are problems in that, high costs are required to provide the barcodes and the RFID tags to the floor sheets of a building, and when the floor is contaminated or damaged, the mobile object cannot precisely perceive the position information. Therefore, there is limitation to utility thereof.

In addition, as shown in FIG. 8, a localization method using a near-infrared ray landmark projector is known. In this method, near-infrared rays are projected onto a landmark on a ceiling of a building, and a localization sensor mounted in the mobile object detects the landmarks and perceives the position and direction, thereby calculating the position thereof. However, this method also has a problem in that position perception range is limited. Moreover, in this method, as shown in FIG. 10, the localization sensor is mounted in the mobile object, so that the perceived position of the mobile object is influenced by vibration caused from unevenness when the mobile object moves. For example, a position L2 perceived when the mobile object is vibrated by unevenness is deviated from LI although the mobile object is at the same position. That is, accuracy of position data greatly decreases.

In addition, as shown in FIG. 9, a localization method for a mobile object using near-infrared ray reflection landmarks is known. In this method, landmarks having near-infrared ray reflection characteristics are attached to the ceiling, and a camera of the mobile object detects the landmarks and obtains the position and direction of the landmarks to calculate the position thereof. However, the method has the same problem as that of the aforementioned method using the near-infrared ray landmark projector. In addition, when a plurality of landmarks are attached to the ceiling in order to increase accuracy, the interior may be disfigured by the landmarks.

In International Publication No. WO 99/52094, a 3D localization system as shown in FIG. 11 is disclosed. The system comprises a first wireless device 12 having a receiver 40 and one or more light emitting diodes (LEDs) 18, two or more corresponding sensors 31 for sensing optical signals emitted from the LEDs 18, a transmitter 34 for transmitting signals to the receiver 40 through wireless connections, and a controller 32 including a means for determining positions of the LEDs.

However, in the aforementioned construction, as shown in FIG. 11, the controller 32 and a sensor assembly 30 is connected through wire connections. As described above, in a case where the controller 32 and the sensor assembly 30 for sensing light of the LED 18 are connected through wire connections, in order to measure a position of the mobile object in a wide area such as a discount store, a plurality of sensor assemblies 30 have to be mounted on the ceiling. In addition, since a single controller 32 is connected to the plurality of assemblies 30 through the wire connections, a installation process is complicated. In addition, due to the complicated wire connections, appearance of the interior after installation is not desirable. In addition, when the moving line of the mobile object is changed, the sensor assemblies 30 have to be rearranged. In addition, in the aforementioned system, extensibility of the system is limited, because the number of sensor assemblies and wireless devices which can be controlled by a single controller is limited.

### DISCLOSURE OF INVENTION

### Technical Problem

In order to solve the aforementioned problems, an object of the present invention is to provide a localization system and method for a mobile object capable of stably obtaining precise position data against changes in light intensity and vibration of the mobile object at lower costs, capable of measuring positions of a plurality of the mobile objects in a wide area, and capable of informing the mobile objects of the positions by measuring them from outside in order to reduce an operation loads of a control system comprised in the mobile object, as compared with a conventional localization system and method for a mobile object.

### TECHNICAL SOLUTION

In order to solve the aforementioned problem, the present invention provides two localization systems and methods as described later.

According to an aspect of the present invention, there are provided a basic localization system including one or more localization modules and one or more sensing modules, and an extended localization system including additional one or more central processing module along with the basic localization module. Each localization system is as follows.

The basic localization system comprises one or more localization modules and one or more sensing modules. The localization module is disposed in the mobile object and comprises one or more optical indicators, an RF transceiving means, and a processing unit for controlling the optical indicators and the RF transceiving means and calculating a position and direction of the mobile object from location information on the one or more optical indicators received from the sensing modules. The sensing module comprises one or more optical sensing means sensing for detecting optical signals emitted from the one or more optical indicators, an RF transceiving means, and a processing unit for controlling the optical sensing means and the RF transceiving means, and calculating the position information on the one or more optical indicators from the optical signals detected by the optical sensing means.

More specifically, the basic localization module according to the present invention mainly comprises two parts. The one part is the localization module which is mounted in the mobile object and requests a localization instruction to one or more sensing module installed in outside for the optical indicator disposed in the mobile object, receives the detected location results from the sensing module and calculates a position and direction of the mobile object based on the received results. The other part is the sensing module which receives the localization instruction from the localization module, detects the optical signal of the optical indicator, calculates location information on the optical indicator and transmits the location information to localization module in real time.

As described above, in the basic localization system of the present invention, a position of the mobile object is measured by the sensing module installed in outside, not by the mobile object itself, and is transmitted to the localization module mounted in the mobile object through wireless communication.

Conventionally, the mobile object such as a service robot comprises an encoder or a gyro sensor therein or comprises a visual system capable of perceiving landmarks fixed to the outside in order to calculate a moving direction and a moving distance thereof.

However, in the conventional system, the current position of the mobile object is not measured and calculated by the outside, but by an own sensor. Therefore, the system using the encoder or the gyro sensor cannot avoid continuous error accumulation, and have to clear the accumulated error in time. In order to clear the error, the visual system capable of perceiving the external landmarks has been used. However, there are problems in that, when the landmarks are perceived, the process of perceiving the landmarks itself has errors therein. In addition, measurement errors occur due to changes in light intensity and vibration of the mobile object as described above (see FIG. 10).

However, in the localization system according to the present invention, a position of the mobile object is not perceived by the mobile object itself, but by the sensing module installed in outside by perceiving a position of the optical indicator mounted in the mobile object and transmitting the position to the mobile object through wireless communication. Therefore, as compared with the conventional system, the system is insensitive to a change in light intensity or vibration of the mobile object, so that relatively stable position data can be obtained. In addition, since the localization module disposed in the mobile object processes the position information on the optical indicator received from the sensing module, the localization module does not have to perform a lot of data processing, thereby greatly reducing system operation loads.

In addition, in the present invention, an extended localization system additionally including a central processing module including an RF transceiving means and a processing unit for controlling the RF transceiving means and calculating a position or a direction of the mobile object from the location information on the one or more optical indicators received from the sensing modules, along with the basic localization system including the localization modules and the sensing modules, is provided.

More specifically, the extended localization system mainly includes three types of modules. The first module is the central processing module for transmitting a instruction for emission of the an optical signal to the optical indicator of the localization module mounted in the mobile object, instructing to the sensing module to detect a location of the optical indicator, and receiving the location results of the optical indicator detected by the sensing module to finally calculate a position and direction of the mobile object. The second module is the localization module which is mounted in the mobile object and processes an optical signal ON/OFF instruction of the optical indicator received from the central processing module. The third module is the sensing module for receiving the localization instruction from the central processing module, detecting the optical signal of the optical indicator, calculating location information on the optical indicator, and transmitting the location information to the central processing module.

In the extended localization system, the sensing module performs the same function as that of the sensing module in the aforementioned basic localization module. However, the extended localization system differs from the basic localization module in that the localization instruction and an input and output of the localization results are performed by the central processing module, not by the localization module disposed in the mobile object. In addition, the localization module in the extended localization system differs from the localization module in the basic localization system in that it performs only a position display function of turning on or off the optical signal of the optical indicator requested from the central processing module.

More specifically, the localization module in the basic localization system has a function of finally calculating a position of the mobile object. However, in the extended localization system, the central processing module finally calculates a position and direction of the mobile object by controlling the localization module and the sensing module.

Similarly to the aforementioned basic localization system, in the extended localization system, a position of the mobile object is not perceived by the mobile object itself, but measured by the sensing module from outside, and is transmitted to the central processing module. Therefore, there is an advantage in that position accuracy and operation loads of the control system comprised in mobile object can be reduced.

In addition, each mobile object does not finally calculate a position thereof, and the central processing module calculates the position by controlling the whole localization system. Therefore, performance requirement of the processing unit of the localization module can be lowered. In addition, the system can be properly employed by an environment in which a plurality of the mobile objects are simultaneously operated and positions of the mobile objects are perceived by the central processing module to control the mobile objects.

In the two localization systems according to the present invention, the RF transceiving means may be a radio frequency (RF) transceiver. The RF transceiver uses a wireless communication method such as ZigBee based on the IEEE 802.15.4 standard, BlueTooth of the IEEE 802.15.1 standard, and WLAN of IEEE 802.11 standard in order to form wireless networks.

As described above, in the aforementioned construction according to the present invention, communications between the modules are performed through wireless networks between RF transceivers disposed in each localization module, sensing module, and central processing module. Therefore, a user may check the current position of the mobile object in real time and periodically monitor the state of the sensing module for maintenance using a wireless network infra structure that is already formed in order to connect with the networks. In addition, in an initial system set up phase, install positions of the sensing modules can be easily changed, and the sensing modules can be added or removed from the wireless network infra structure.

Calibration of the sensing module can be performed by using the wireless communication network to upload the calibrated data to the sensing module.

In addition, as a localization method for a mobile object using the aforementioned basic localization system according to the present invention, there is provided a localization method including steps of: requesting an optical indicator to emit an optical signal by a processing unit of a localization module including one or more optical indicators, the processing unit, and an RF transceiving means and transmitting a localization instruction for the optical indicator to one or more sensing modules through the RF transceiving means; receiving the optical signal of the optical indicator by an optical sensing means of the sensing module including one or more optical sensing means, an RF transceiving means, and a processor unit; calculating location information on the optical indicator by using the received optical signal and a predetermined position of the sensing module by the processing unit of the sensing module, and transmitting the location information to the localization module through the RF transceiving means; and calculating the position of the mobile object from the received position information on the optical indicator by the processing unit of the localization module.

In addition, as a localization method for a mobile object using the aforementioned extended localization system according to the present invention, there is provided a localization method for a mobile object including steps of: requesting an optical indicator of a localization module including one or more optical indicators, an RF transceiving means, and a processing unit to emit an optical signal through the RF transceiving means by a processor unit of a central processing module including the processor unit and the RF transceiving means thereof, and transmitting a localization instruction for the optical indicator to one or more sensing modules; receiving the optical signal of the optical indicator by an optical sensing means of the sensing module including one or more optical sensing means, an RF transceiving means, and a processing unit; calculating location information on the optical indicator by using the received optical signal and a predetermined location of the sensing module by the processor unit of the sensing module, and transmitting the location information to the central processing module through the RF transceiving means; and calculating the position of the mobile object from the received location information on the optical indicator by the processing unit of the central processing module.

In these methods, there are advantages in that accuracy increases and operation loads of the control system disposed in mobile object can be reduced. In addition, when a plurality of the mobile objects are operated, positions of the mobile objects can be easily perceived by the central processing module in order to control the mobile objects.

In the present invention, the aforementioned two localization methods employ various selection for calculating a position and direction of a mobile object according to the number and types of optical sensing means used for the sensing modules of the localization system and the number of the optical indicators disposed in the mobile objects.

First, a system in which only a single optical indicator is disposed in a mobile object may employ a method in which the localization module and the central processing module receive current location information on the single optical indicator from the sensing module and continuously compare the location information with previously received location information to calculate a position and a moving direction of the mobile object in real time.

In addition, a system in which two or more optical indicators are disposed in the mobile object may employ a method in which the localization module and the central processing module can calculate not only the current position but also the direction of the mobile object from location information on the two or more optical indicators received from the sensing module.

Here, when the optical sensing means of the sensing module is a charged coupled device (CCD) sensor or a complementary metal-oxide semiconductor (CMOS) sensor, the two or more optical indicators disposed in the mobile object simultaneously emit light, and the CCD sensor or the CMOS sensor simultaneously detect light emission positions of the two or more optical indicators disposed in the mobile objects. Thereafter, the light emission positions are transmitted to the localization module or the central processing module in order to calculate a position and direction of the mobile object.

However, when the optical sensing means of the sensing module is a position sensitive detector (PSD) sensor, two or more optical indicators disposed in the mobile object sequentially emit light, and the sensing module detects each position of the optical indicator which emit light. Thereafter, the localization module or the central processing module finally calculates a position and direction of the mobile object by using sequentially received position information on the optical indicators.

As described above, when two or more optical indicators are used, a direction along with a position of the mobile object can be easily detected without data confusion although a plurality of the mobile objects are operated.

In addition, when the PSD sensor is used as an optical sensing means of the sensing module, measured position values are represented as relative current differences, so that the optical indicator can obtain position data by simple hardware configuration. Therefore, when the PSD sensor is used as the optical sensing means, data acquisition and function implementation of data transmission for the sensing modules using wireless communication are possible by using a single low-cost general purpose micro-processor. Accordingly, there is an advantage in that a position and direction of the mobile object can be precisely perceived by a simple and low-cost construction.

In order to measure positions of one or more optical indicators in the sensing module using the aforementioned localization method, the sensing module must have information on perpendicular distances from the optical sensor to the optical indicator.

The distance information can be obtained by using two methods. In the first method, in the step of transmitting a localization instruction to the sensing module through the RF transceiving means by the localization module or the central processing module, a height above a reference floor to the optical indicator is transmitted together, so that on the basis of the height above the reference floor to the optical sensor predetermined in the sensing module, a distance from the optical sensor to the optical indicator can be obtained. In the second method, two or more optical sensors are disposed by a predetermined interval in the sensing module, and distances from the two or more optical sensors to the same optical indicator are measured. Thereafter, information on the distances from the optical sensors to the optical indicator can be calculated by using the stereo method. In general, the mobile object moves with a fixed height above the floor, so that distance information can be properly obtained in the first method, and on the basis of the distance information, information on a position can be also obtained.

### Advantageous Effects

As described above, in the localization system and method according to the present invention, a position of the mobile object is not perceived by the mobile object itself, but by the sensing module installed in outside by detecting a location of the optical indicator mounted in the mobile object and transmitting the location information to the mobile object. Therefore, as compared with the conventional system and method, the system is insensitive to a change in light intensity or vibration of the mobile object, so that relatively stable position data can be obtained. In addition, a lot of data processing loads for calculating position information from the optical signal is not required in the mobile object. Therefore, operation loads of the system disposed in the mobile object can be greatly reduced.

In addition, according to the present invention, a plurality of the sensing modules are used for localization of a single mobile object in real time. Therefore, errors in localization of the mobile object greatly reduce. Especially, perception errors at the border of a light receiving region of the two sensing modules also can be reduced.

In addition, according to the present invention, since communications between the sensing modules and the localization modules are performed by using wireless networks, a user can check the current position of the mobile object using the wireless communication network infra structure to periodically monitor the state of the sensing module for maintenance.

### BRIEF DESCRIPTION OF THE DRAWINGS

FIG. 1 is a schematic view showing a localization system according to a first embodiment of the present invention;

FIG. 2 is a block diagram showing a localization system according to a first embodiment of the present invention;

FIG. 3 is a flowchart showing a localization system according to a first embodiment of the present invention;

FIG. 4 is a block diagram showing a localization system according to a second embodiment of the present invention;

FIG. 5 is a flowchart showing a localization system according to a second embodiment of the present invention;

FIG. 6 is a schematic view showing a conventional localization system using ultrasonic triangulation;

FIG. 7 is a schematic view showing a conventional localization system using floor sheets having barcodes or radio frequency identification RFID) Tags;

FIG. 8 is a schematic view showing a conventional localization system using landmarks and a near-infrared ray projector;

FIG. 9 is a schematic view showing a conventional localization system using near-infrared ray reflection landmarks;

FIG. 10 is a schematic view showing a change in a position perceived by a mobile object that is influenced by vibration in a conventional localization system in that the mobile object perceives landmarks; and

FIG. 11 is a schematic view showing a conventional 3D localization tracking system.

### DESCRIPTION OF REFERENCE NUMERALS AND SIGNS

1a, 1b: service robot

2a, 2b: localization module

3: ceiling

4a, 4b: sensing module

### Best Mode for Carrying Out the Invention

Hereinafter, two constructions according to the present invention are described with reference to exemplary embodiments, and various changes in form and details may be made therein without departing from the idea and scope of the present invention. Therefore, the present invention is not limited to the exemplary embodiments.

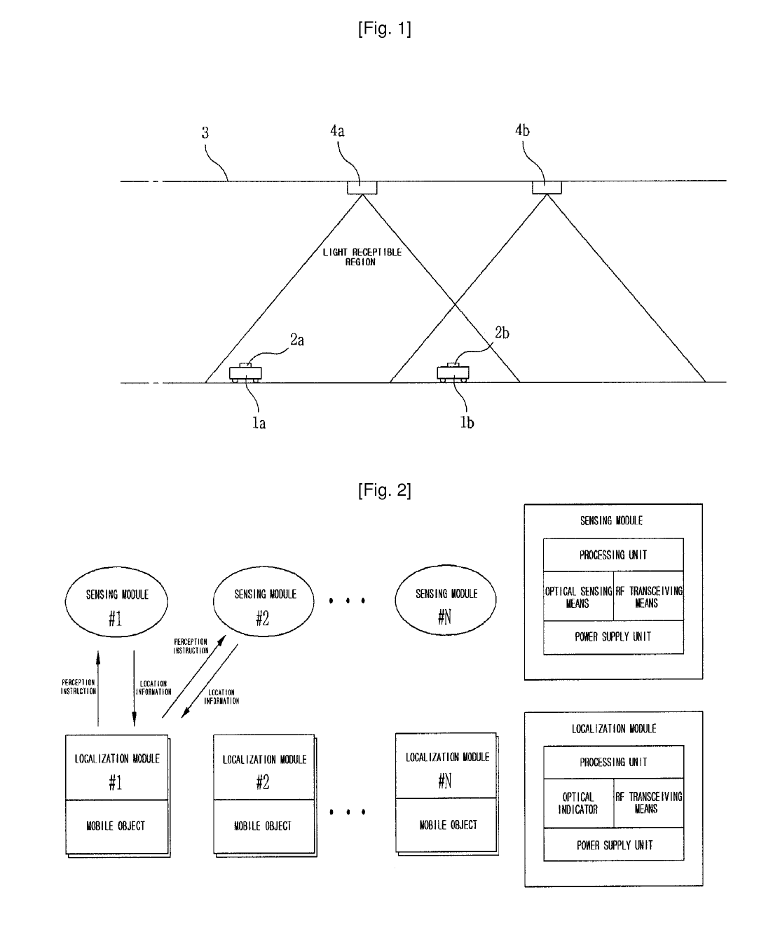

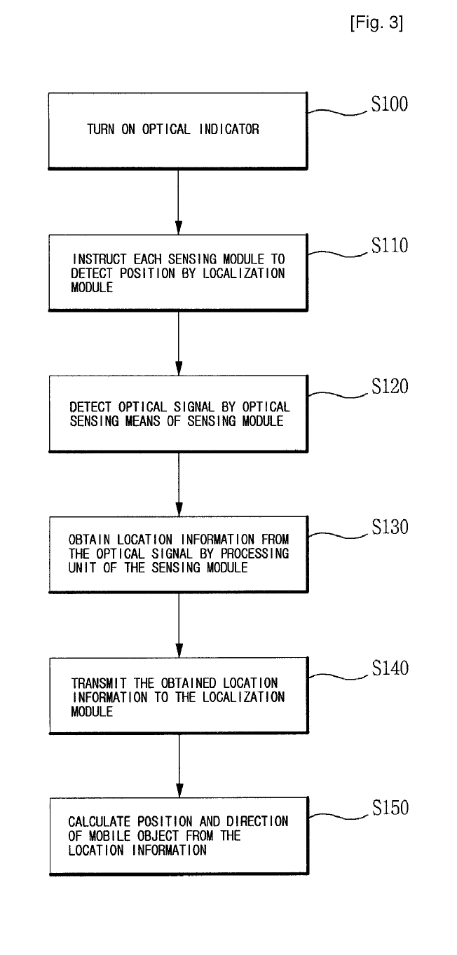

FIG. 1 is a schematic view showing a localization system according to a first embodiment of the present invention. FIG. 2 is a block diagram showing a localization system according to a first embodiment of the present invention. FIG. 3 is a flowchart showing a localization system according to a first embodiment of the present invention.

As shown in FIG. 1, a basic localization system comprises localization modules mounted on mobile objects, that is, service robots la and lb and sensing modules 4a and 4b fixed to the wall or the ceiling of a building.

As shown in FIG. 2, the localization module 2a or 2b comprises an optical indicator emitting an optical signal which is detected by the sensing modules 4a and 4b in order to obtain a position of the mobile object, an RF transceiving unit for wireless communication with the sensing modules, a processor unit for controlling the optical indicator and the RF transceiving unit to implement functions thereof and finally calculating a position and direction of the mobile object using location information on the optical indicator received from the sensing modules that will be described later, and a power supply unit for supplying energy for driving the aforementioned components.

In addition, as shown in FIG. 2, the basic localization system according to the present invention may comprise a plurality of the localization modules #1, #2, to #N and a plurality of the sensing modules #1, #2, to #N. Although localization instructions for only the single localization module #1 and the two sensing module #1 and #2 through the RF transceiving units and transmission processes of the corresponding position information are described, the plurality of the localization modules and the plurality of the sensing modules can also perform localization by the same processes.

Here, when the mobile object needs only position data thereof, the localization module can implement the function for obtaining the position data by using a single optical indicator. However, when the mobile object needs not only the position information but also direction information thereof, a construction having two or more optical indicators per a single localization module may be employed.

When a plurality of the mobile objects are operated as described in the first embodiment, the sensing module cannot exclusively provide position information on a specific single mobile object, so that it is difficult to provide direction information to the mobile object. Accordingly, the direction information is calculated by accumulating, comparing, and evaluating the position information in the processing unit of the localization module disposed on the mobile object. Therefore, as the processing unit calculates a position and direction of the mobile object based on location information on each of the two or more optical indicators, the processing unit has an advantage in that calculation can be simplified and operation loads can be reduced.

The optical indicator may employ various types. In general, a light emitting diode (LED) is used as the optical indicator. In order to detect a precise emitting location by a good sensitivity of an optical sensor, a good selection of optical parameters is important so that a peak sensitivity wavelength of the optical sensor and a dominant peak wavelength of the LED are coincident with each other. The LED may use infrared rays having a wavelength in a range of 800 nm or more so that the infrared rays are insensitive to a change in light intensity during the day and night and do not have a harmful effect on human beings.

The wireless communication means uses the RF transceiver as described above. The RF transceiver may use one from among ZigBee based on the IEEE 802.15.4 standard, BlueTooth of the IEEE 802.15.1 standard, and WLAN of IEEE 802.11 standard.

The processor of the localization module may use an 8-bit or more advanced micro-processor. The LED, the RF transceiver, and the processing unit may be connected in wire connections.

In order to supply energy for driving the aforementioned components, electric power may be supplied through a power cable. However, since the localization module is disposed in the mobile object, a battery is preferably used.

As shown in FIG. 2, the sensing module comprises an optical sensing means for detecting optical signals emitted from the optical indicators of the localization modules, a wireless communication means for communication with the localization modules, a processing unit for controlling the optical sensing means and an the wireless communication means to implement functions thereof and comparing the optical signals detected by the optical sensing means with the location information thereof to calculate position information on the optical indicator, and a power supply unit for driving the components.

As the optical sensing means, a 2D charged coupled device (CCD) sensor, a 2D complementary metal-oxide semiconductor (CMOS) sensor, or a 2D position sensitive detector (PSD) sensor may be used.

When the PSD sensor is used as an optical sensing means, measured position values are represented as relative current differences, so that the optical sensing module can obtain position data by simple hardware configuration. Therefore, data acquisition and data transmission using wireless communication for the sensing modules can be implemented using a single low-cost general purpose 8-bit microprocessor. Accordingly, the PSD sensor may be preferably used as the optical sensing means.

When the 2D CCD sensor or the CMOS sensor is used as an optical sensing means, a lot of 2D data has to be obtained and processed, so that a 32-bit or more advanced processor having a performance higher than that of the PSD sensor has to be used in order to calculate a position of the mobile object. Then the functions of the sensing module can be well implemented. In this case, in order to improve a data processing speed in the sensing module, a processor in charge of image processing and a processor in charge of data communication can be separately implemented.

The wireless communication means also uses the RF transceiver that is used for the localization module. As described above, a performance or a type of the processor in the processing unit may be changed according to a type of the used optical sensing means.

The sensing modules are generally installed under the ceiling or on the wall of a building or a house in order to precisely detect a position of the mobile object which moves and inform the mobile object of the position. The sensing module comprises a power supply unit for receiving AC voltage and converting the AC voltage to DC voltage in order to drive the internal sensors and the processing unit.

In addition, the aforementioned localization modules and the sensing modules may be a single module or a plurality of the modules. Data communication between all component modules uses a local wireless communication network so as not to break the communication with the mobile object.

More specifically, the RF transceiver disposed in the localization modules and the sensing modules can perform full duplex communication and have their own address, so that many-to-many(n: n) or one-to-many(l;n) communication is possible. Therefore, a single localization module can perform communication with a plurality of the sensing modules to receive the location results, and a signal sensing module can process localization request instructions of a plurality of the localization modules.

For wireless communication between a plurality of the modules, all sensing modules and localization modules are mutually connected to the same logical wireless communication network. By using the wireless communication network, the mobile object can correspond to a request for position information thereof from the outside environment and can faithfully perform services.

More specifically, a method of performing the interface between the mobile object and the sensing modules in the outside environment can be executed by using Wireless Local Area Network (WLAN) or Wireless Personal Area Network (WPAN). Among these, as a home network solution, the embodiment of the present invention employs a ZigBee solution.

Next, a localization method for a mobile object using the basic localization system according to the first embodiment of the present invention will be described.

As shown in FIG. 3, in the localization method for a mobile object according to the first embodiment of the present invention, a step of turning on the optical indicator disposed in the mobile object by the localization module (operation S100), a step of transmitting a localization request instruction to the sensing modules (the sensing modules may be one or a plurality of the sensing modules adjacent to the mobile object or all sensing modules) through the RF transceiver by the localization module (operation S110), a step of detecting a location of the optical indicator through the optical sensing means comprised in the sensing modules which receive the localization request instruction (operation S120), a step of calculating location information on the optical indicator by converting the location of the optical indicator into a relative position to the predetermined position thereof by the processing unit of the sensing module (operation S130), a step of transmitting the calculated location information on the optical indicator to the localization module through the RF transceiver of the sensing module (operation S140), and a step of calculating a position and direction of the mobile object from the location information on each optical indicator by the processing unit of the localization module (operation S150) are performed to perceive the position of the mobile object.

In this localization method, the current position of the mobile object itself can be perceived by a single optical indicator in the localization module. However, when information on a moving direction of the mobile object is requested, at least two optical indicators may be used.

In addition, in a method of measuring a direction of the moving object, when the optical sensing means is the 2D CCD sensor or the CMOS sensor, optical sensors can be detected even though two or more optical indicators of the localization modules are simultaneously turned on. Therefore, a direction of the mobile object can be measured.

However, when the optical sensing means is the PSD sensor, the PSD sensor cannot simultaneously detect optical signal of two or more optical indicators. Therefore, after the localization module turns on a first optical indicator from among the two or more optical indicators and receives location information on the first optical indicator detected by the PSD sensor from the sensing module, the localization module then turns on a second optical indicator and receives position information on the second optical indicator detected by the PSD sensor from the sensing module. Through the processes, a single localization module sequentially receives location information on all optical indicators, and then calculates a direction of the mobile object from the location information.

In addition, in the localization method for the mobile object according to the first embodiment of the present invention, as shown in FIG. 1, when the mobile object 1b is located at the border of a light receptible region of the optical sensing means, due to optical characteristics of an optical lens used for the optical sensing means, errors in localization inevitably increases. However, as the mobile object 1b receives position information on the localization module 2b disposed on the mobile object 1b from a plurality of the sensing modules, for example, the sensing modules 4a and 4b and takes an arithmetical average, there is an advantage in that errors in localization for the mobile object 1b at the border of the light receptible region of the sensing modules decrease. In other words, inaccuracy of position data decreases.

As described above, when a plurality of the sensing modules are used to detect a position of a single mobile object, errors in the localization for the mobile object greatly decreases comparing with a single sensing module is used.

In order to obtain position information on the optical indicator from optical signals detected by the optical sensing means according to the first embodiment of the present invention, the well known triangulation is used.

When a mobile object such as a cleaning robot performs services in a building or a house, since a height above the floor to the ceiling is uniform, a (X, Y, Z) position of the mobile object can be well perceived by using only a single optical sensing means.

The optical indicator of the mobile object has a fixed height above the floor, so that the height above the floor may be provided to the sensing modules as a Z value in advance. On the bases of the Z value, the sensing modules can calculate a (X, Y) position of the mobile object.

In a case where the Z value is not fixed to be provided as a constant value, the sensing modules have to three-dimensionally calculate a position of the optical indicator of the mobile object. Therefore, the sensing module has to comprise two optical sensing means, and an optical signal of a single optical indicator is detected by two optical sensing means to calculate three dimensional positions. A method of calculating three dimensional positions may employ the method disclosed in International Publication WO 99/52094.

### Mode for the Invention

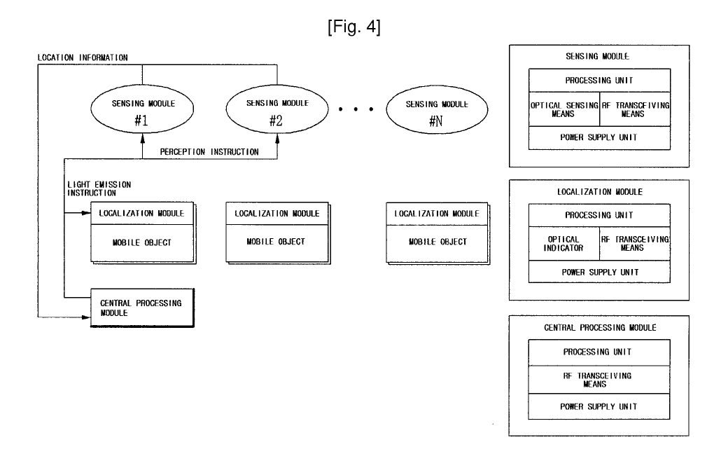

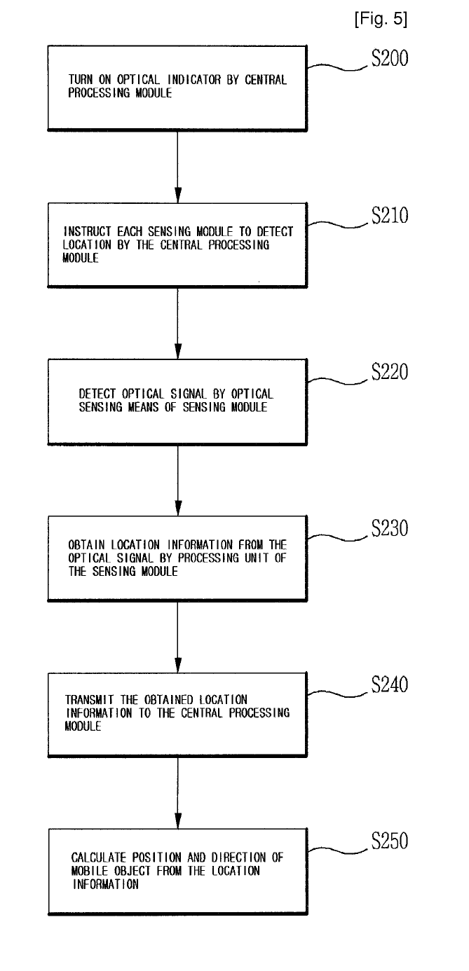

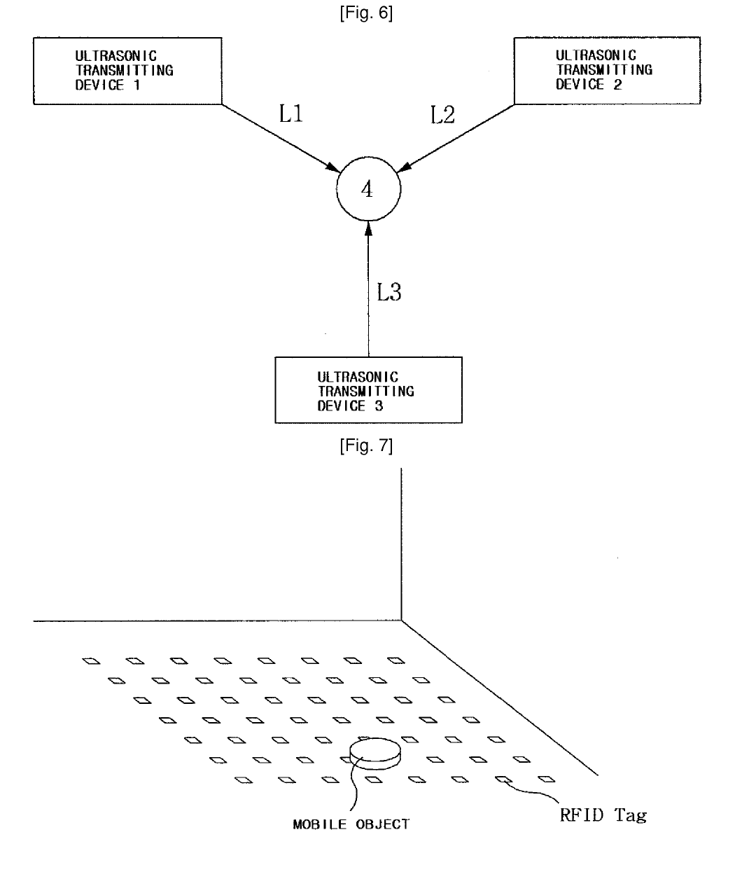

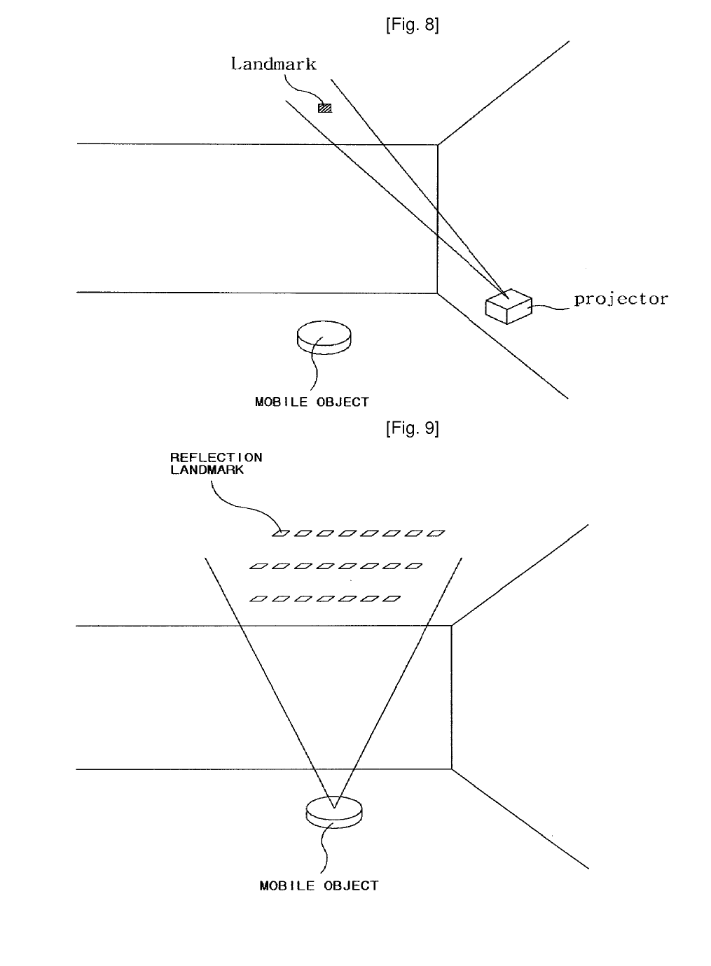

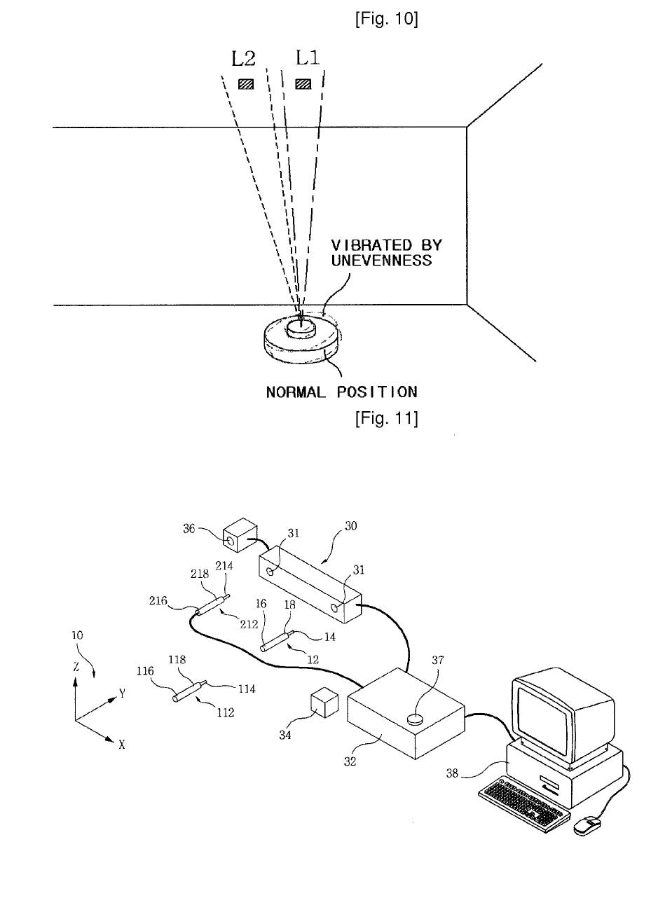

Hereinafter, a localization system and method according to a second embodiment of the present invention will be described. FIG. 4 is a block diagram showing a localization system according to a second embodiment of the present invention. FIG. 5 is a flowchart showing a localization system according to a second embodiment of the present invention.

As shown in FIG. 4, a localization system according to the second embodiment of the present invention has basically the same structure as that of the localization system in the first embodiment. Particularly, in the second embodiment, a central processing module along with the localization modules and the sensing modules is additionally provided.

Since the localization modules and the sensing modules have the same structure as those in the first embodiment, hereinafter, a structure and operations of only the central processing modules are described.

As shown in FIG. 4, the central processing module comprises an RF transceiving means for wireless communication with the localization modules and the sensing modules, a processing unit for controlling the RF transceiving means to implement the functions thereof and finally calculating a position and direction of the mobile object using position information on the optical indicator received from the sensing modules, and a power supply unit for supplying energy for driving the aforementioned components.

The RF transceiving means uses the RF transceiver that is used for the localization module and the sensing module. The processing unit may use a 32-bit or more advanced microprocessor or a general-purpose single board computer.

According to the aforementioned construction, position information on optical indicators disposed in a plurality of the mobile objects is not transmitted to each mobile object, and all the position information is transmitted to the central processing module. Therefore, the central processing module finally calculates positions and directions of the mobile objects. According to the construction, the positions and the directions of the mobile objects can be calculated together by the high-performance processor disposed in the central processing module. Therefore, there is an advantage in that performance of the processing unit comprised in each mobile object can be lowered. In addition, although a plurality of the mobile objects are operated, a user can easily control and manage the mobile objects using the central processing module.

Next, a localization method for a mobile object using the localization system according to the second embodiment of the present invention will be described.

As shown in FIG. 5, in the localization method according to the second embodiment of the present invention, a step of turning on an optical indicator disposed in a mobile object by the central processing module (operation S200), a step of transmitting a localization request instruction to the sensing modules (the sensing modules may be one or a plurality of the sensing modules adjacent to the mobile object or all sensing modules) through the RF transceiver by the central processing module (operation S210), a step of detecting a location of the optical indicator through the optical sensing means disposed in the sensing modules which receive the localization request instruction (operation S220), a step of calculating position information on the optical indicator by converting the location of the optical indicator into a relative location to the predetermined location thereof by the processing unit in the sensing module (operation S230), a step of transmitting the calculated location information on the optical indicator to the central processing module through the RF transceiver of the sensing module (operation S240), and a step of calculating a position and direction of the mobile object from the location information on each optical indicator by the processing unit of the central processing module (operation S250) are performed to perceive the position of the mobile object.

### INDUSTRIAL APPLICABILITY

The localization system and method according to the present invention can be employed by various industrial fields. For example, when a service robot employs the localization system and method, the service robot can perceive a precise position and moving direction thereof at lower costs. Therefore, the present invention helps popularize the service robot.

1. A localization system for a mobile object comprising one or more localization modules and one or more sensing modules,
wherein the localization module is mounted in the mobile object and comprises one or more optical indicators, an RF transceiving means, and a processing unit for controlling and driving the optical indicators and the RF transceiving means and calculating a position and direction of the mobile object from location information on the one or more optical indicators received from the sensing modules,
wherein the sensing module comprises one or more optical sensing means detecting optical signals emitted from the one or more optical indicators, an RF transceiving means, and a processing unit for controlling and driving the optical sensing means and the RF transceiving means and calculating the location information on the one or more optical indicators from the optical signals detected by the optical sensing means.

2. The localization system for a mobile object according to claim 1, further comprising a central processing module comprising an RF transceiving means and a processing unit for controlling and driving the RF transceiving means and calculating a position and direction of the mobile object from the location information on the one or more optical indicators of the localization modules received from the sensing modules, along with the localization modules and the sensing modules.

3. The localization system for a mobile object according to claim 1, wherein the RF transceiving means is a radio frequency (RF) transceiver.

4. The localization system for a mobile object according to claim 1, wherein the number of the optical indicators comprised in the localization module is two or more.

5. The localization system for a mobile object according to claim 1, wherein the optical sensing means is a charged coupled device (CCD) sensor, a complementary metal-oxide semiconductor (CMOS) sensor, or a position sensitive detector (PSD) sensor.

6. The localization system for a mobile object according to claim 1, wherein the optical indicator is a light emitting diode (LED).

7. The localization system for a mobile object according to claim 1, wherein the sensing module is disposed on the wall or the ceiling of a building.

8. The localization system for a mobile object according to claim 3, wherein the RF transceivers use a method from among ZigBee based on the IEEE 802.15.4 standard, Bluetooth based on the IEEE 802.15.1 standard, and WLAN of IEEE 802.11 standard.

9. The localization system for a mobile object according to claim 4, wherein the optical indicator is an infrared ray emitting diode, and the optical sensing means is a PSD sensor.

10. The localization system for a mobile object according to claim 5, wherein, in the sensing module, a processor in charge of image processing is separated from a processor in charge of data communication.

11. A localization method comprising steps of:
requesting an optical indicator to emit an optical signal by a processing unit of a localization module comprising one or more optical indicators, the processing unit, and an RF transceiving means and transmitting a localization instruction for the optical indicator to one or more sensing modules through the RF transceiving means;
detecting the optical signal of the optical indicator by an optical sensing means of the sensing module comprising one or more optical sensing means, an RF transceiving means, and a processing unit;
calculating location information on the optical indicator by using the detected optical signal and a predetermined location of the sensing module by the processing unit of the sensing module, and transmitting the location information to the localization module through the RF transceiving means; and
calculating the position of the mobile object from the received location information on the optical indicator by the processing unit of the localization module.

12. A localization method for a mobile object comprising steps of:
requesting an optical indicator of a localization module comprising one or more optical indicators, an RF transceiving means, and a processing unit to emit an optical signal through the RF transceiving means by a processing unit of a central processing module comprising the processing unit and the RF transceiving means thereof, and transmitting a localization instruction for the optical indicator to one or more sensing modules;
detecting the optical signal of the optical indicator by an optical sensing means of the sensing module comprising one or more optical sensing means, an RF transceiving means, and a processing unit;
calculating location information on the optical indicator by using the detected optical signal and a predetermined location of the sensing module by the processing unit of the sensing module, and transmitting the location information to the central processing module through the RF transceiving means; and
calculating the position of the mobile object from the received location information on the optical indicator by the processing unit of the central processing module.

13. The localization method for a mobile object according to claim 11, wherein the number of the optical indicators of the localization module is two or more, and the two or more optical indicators simultaneously emit optical signals thereof.

14. The localization method for a mobile object according to claim 11, wherein the number of the optical indicators is two or more, wherein the optical sensing means is a PSD sensor, wherein the two or more optical indicators sequentially emit optical signals thereof, and wherein, in the step of calculating a position of the mobile object from the received location information on the optical indicators, the position and a direction of the mobile are calculated from the sequentially received location information on the optical indicators.

15. The localization method for a mobile object according to claim 12, wherein the number of the optical indicators of the localization module is two or more, and the two or more optical indicators simultaneously emit optical signals thereof.

16. The localization method for a mobile object according to claim 12, wherein the number of the optical indicators is two or more, wherein the optical sensing means is a PSD sensor, wherein the two or more optical indicators sequentially emit optical signals thereof, and wherein, in the step of calculating a position of the mobile object from the received location information on the optical indicators, the position and a direction of the mobile are calculated from the sequentially received location information on the optical indicators.

17. The localization system for a mobile object according to claim 2, wherein the RF transceiving means is a radio frequency (RF) transceiver.

18. The localization system for a mobile object according to claim 2, wherein the number of the optical indicators comprised in the localization module is two or more.

19. The localization system for a mobile object according to claim 2, wherein the optical sensing means is a charged coupled device (CCD) sensor, a complementary metal-oxide semiconductor (CMOS) sensor, or a position sensitive detector (PSD) sensor.

20. The localization system for a mobile object according to claim 2, wherein the optical indicator is a light emitting diode (LED).
